(19) United States
(12) Patent Application Publication
(10) Pub. No.: US 2002/0033079 A1
(43) Pub. Date: Mar. 21, 2002

(54) Insulating, composite, hybrid-handle lineman's pliers

(76) Inventors: Gregory A. Zurbuchen, Kenosha, WI (US); Dean J. Iwinski, Muskegon, WI (US)

Correspondence Address: Harold V. Stotland, Seyfarth Shaw, Suite 4200, 55 East Monroe Street, Chicago, IL, 60603-5803, US

(21) Appl. No.: 09/933,322

(22) Filed: Aug. 20, 2001

Related U.S. Application Data
(60) Provisional application No. 60/230,553, filed on Sep. 5, 2000.

(51) Int. Cl. B25B 7/00

(52) U.S. Cl. 81/427.5

(57) ABSTRACT

Insulating lineman's pliers have composite, electrically insulating handles including a core having an inner body formed of a glass-fiber-reinforced polyester pultrusion and over-braided with glass-fiber-reinforced epoxy braided layers, the core being overmolded with an elastomeric grip. The core inner bodies of the handles have axial bores in one end thereof in which are press-fitted first ends of knurled coupling pins, the other ends of which are press-fitted in bores in the ends of the metal heads, which are pivotally interconnected and respectively define plier jaws.

### CROSS REFERENCE TO RELATED APPLICATION

This application claims the benefit of the filing date of U.S. Provisional Application No. 60/230,553, filed Sep. 5, 2000, entitled “Insulating, Composite, Hybrid-Handle Lineman's Pliers.”

### BACKGROUND

This application relates to hand tools and, in particular, tools of the electrically insulated or insulating type, which are designed for safe use in environments which are exposed to potentially dangerous electrical voltages or currents. Such tools may be used, for example, by electric utility linemen.

Insulated hand tools, including pliers, have been offered by a number of different manufacturers. Such tools commonly include standard metal tool parts, such as handles, provided with electrically insulating coatings or covers formed of a suitable plastic or other electrically insulating material. While such tools work well when undamaged, they may put the user at risk in the event that the electrically insulating cover or coating becomes damaged, such as by being punctured, cut, worn away, or the like, because the basic core of the handle material is formed of electrically conducting metal.

It is also known to provide hand tools wherein the entire handle portion of the tool is formed of an electrically insulating material, such as a composite material. Such tools are disclosed, for example, in U.S. Pat. Nos. 5,259,277, 5,271,300, 5,448,932, 5,485,641, 5,713,251, 5,875,693, 5,970,826, 6,029,547. However, such insulating handles have not heretofore been adapted for use with pliers, wherein metal portions of the pliers head must remain exposed for effective use in gripping, cutting and the like.

### SUMMARY

There is disclosed in this application a pliers tool which avoids disadvantages of prior such tools while affording additional structural and operating advantages.

An important aspect is the provision of a hand tool with a handle made entirely of electrically insulating material and adapted to be coupled to an electrically conducting head portion.

Another aspect is the specific construction of the tool handle to achieve adequate strength and beneficial ergonomic advantages.

Another aspect is the provision of a unique technique for interconnecting electrically insulating handles with electrically conducting tool parts.

### BRIEF DESCRIPTION OF THE DRAWINGS

For the purpose of facilitating an understanding of the invention, there are illustrated in the accompanying drawings preferred embodiments thereof, from an inspection of which, when considered in connection with the following description, the invention, its construction and operation, and many of its advantages should be readily understood and appreciated.

FIG. 1 is a front elevational view of a pliers tool embodiment in the closed position;

FIG. 2 is a view similar to FIG. 1, in partial section, to illustrate internal construction;

FIG. 3 is an enlarged front elevational view of the head assembly of the tool of FIG. 1 in partial section; and

FIG. 4 is an enlarged front elevational view of one of the connecting pins of the tool of FIG. 1.

### DETAILED DESCRIPTION

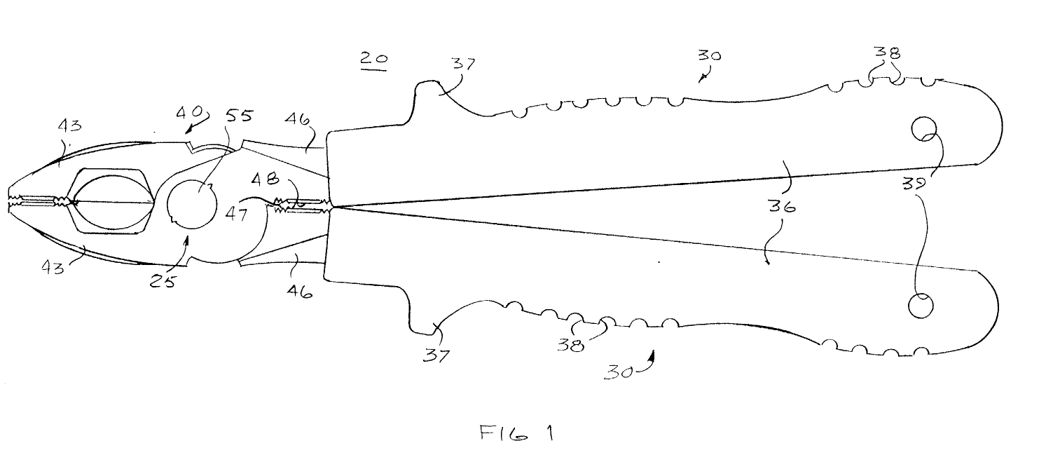

Referring to FIGS. 1-3, there is illustrated a pliers tool, generally designated by the numeral 20, which includes two crossed levers 21interconnected at a pivot joint 25, all in a known manner. The levers 21 are constructed substantially as mirror images of each other and, therefore, only one will be described in detail.

Each lever 21 includes a handle 30 formed entirely of electrically insulating material. The handle 30 has an elongated cylindrical core 31 which includes an inner body 32 which may be formed of a glass-fiber-reinforced polyester pultrusion. The inner body 32 is covered with a sheath 33 of additional electrically insulating material. In particular, the inner body 32 may be over-braided with glass-fiber-reinforced epoxy braided layers. The pultruded inner body 32 provides bending strength and stiffness, while the braided sheath 33 provides torsional strength and stiffness and prevents splitting of the core 31 during assembly and use. Formed in one end of the inner body 32 is an axial bore 34 (FIG. 2) provided with a tapered counterbore 35.

The core 31 is overmolded, such as by injection molding, with a grip 36 formed of another electrically insulating material, which may be an elastomeric material, to provide cushioning and improved frictional gripping. The grip 36 is designed with an ergonomic contour which comfortably fits a user's hand, and may be provided adjacent to the forward end thereof with a raised thumb rest 37. Grooves 38 may be longitudinally spaced along raised portions of the laterally outer side of the grip 36 to provide improved gripping. A hole 39 may be formed transversely through the handle 30 adjacent to its distal end to facilitate hanging the tool for storage or the like.

Each lever 21 also includes a head 40 including a main body portion 41 having a circular bore 42 formed transversely therethrough. Projecting forwardly from the main body portion 41 is a jaw 43 having serrated gripping surfaces 44 adjacent to the distal end and a cutting edge 45 adjacent to the main body portion 41. Projecting rearwardly from the main body portion 41 is a neck 46 provided along one side thereof with a serrated grip surface 47. Formed in the distal end of the neck 46 is a cylindrical bore 49 having an axis inclined to the grip surface 47. The head may be formed of a suitable metal, such as a suitable steel.

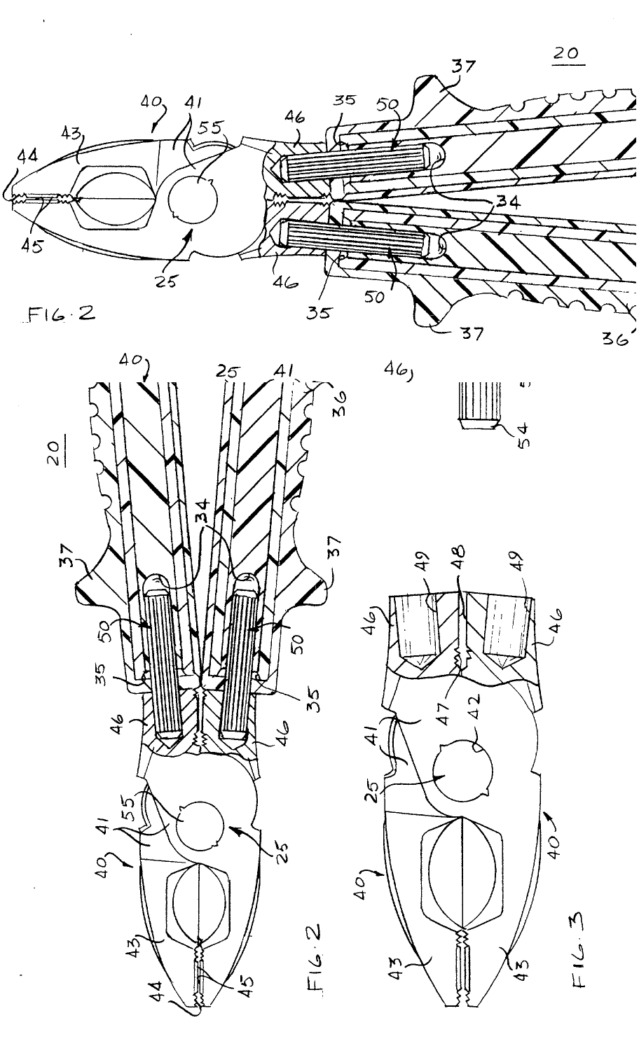

Referring also, to FIG. 4, the handle 30 and the head 40 of each lever 21 are interconnected by a metal pin 50, which may be formed of a suitable steel and has a longitudinally knurled outer surface 51 and is provided with a chamfer 54 at each end. In assembly, one end of each pin 50 is press fit into the bore 49 of the associated head 40, insertion being facilitated by the chamfer 54, and the other end of each pin 50 is press fit into the bore 34 of the associated finished handle 30, insertion being facilitated by the chamfer 54 and the counterbore 35. When the two levers 21 have been thus assembled they are arranged in standard crossed configuration with the bores 42 of the main body portions 41 aligned for receiving a suitable rivet or other pivot pin device 55 to pivotally interconnect the levers 21 for pivotal movement between a closed position, illustrated in FIGS. 1 and 3, and an open position (not shown) in a known manner, the joined heads 40 forming a head assembly.

It will be appreciated that the gripping surfaces 44 of the levers 21 cooperate for gripping associated objects, while the cutting edges 45 cooperate for cutting associated objects in a known manner. Similarly, additional gripping and cutting may be provided by cooperation of the grip surfaces 47 and the cutting edges 48 between the handles 30.

There results an insulating, composite pliers tool 20 which is operable for safely gripping, handling and cutting wires and manipulating fasteners or other components in live electrical environments. Prototype units have demonstrated both dielectric and mechanical strength values which exceed the standards for such tools. The pliers 20 provides a much higher level of safety and electrical insulating capability because the entire handles are constructed of insulating material, so that the insulating characteristics cannot be compromised by misuse or damage. The pliers 20 are also characterized by ease and economy of manufacture and assembly.

While the heads 40 and the pins 50 are preferably formed of metal, it will be appreciated that they could be formed of other materials. Similarly, it will be appreciated that other types of electrically insulating materials than those disclosed above could be utilized for the handles 30, as long as they have the necessary structural characteristics. Also, while the disclosed embodiment is a pliers tool, it will be appreciated that the disclosed principles are also applicable to other pivoting-lever type tools such as cutters, crimping tools and the like.

While a particular embodiment of the present invention has been shown and described, it will be obvious to those skilled in the art that changes and modifications may be made without departing from the broader aspects of the disclosed pliers tool. The matter set forth in the foregoing description and accompanying drawings is offered by way of illustration only, and not as a limitation.

What is claimed is:

1. A pivoting lever hand tool comprising:
a head assembly including a pair of pivotally coupled jaws, the head assembly having a first socket formed therein,
a handle formed of electrically insulating material and having a second socket formed in an end thereof, and
a connecting pin having a first end fixedly and permanently secured in the first socket and a second end fixedly and permanently secured in the second socket.

2. The hand tool of claim 1, wherein the head assembly is formed of metal.

3. The hand tool of claim 1, wherein the head assembly includes a pair of pivotally coupled heads respectively having the jaws formed thereon.

4. The hand tool of claim 3, wherein each head has a neck portion, the first socket being formed in a neck portion.

5. The hand tool of claim 1, wherein the pin is press-fitted in each of the first and second sockets.

6. The hand tool of claim 1, wherein the pin is formed of metal.

7. The hand tool of claim 1, wherein the pin has a longitudinally knurled outer surface.

8. The hand tool of claim 1, wherein each end of the pin is chamfered.

9. The hand tool of claim 1, wherein the handle includes a core formed of a first relatively rigid material and an outer grip sheath covering the core and formed of an elastomeric material.

10. The hand tool of claim 9, wherein the core includes an inner body formed of a glass-fiber-reinforced polyester pultrusion and an outer body formed of glass-fiber-reinforced epoxy braided material.

11. A pivoting lever hand tool comprising:
a head assembly including a pair of pivotally coupled heads respectively defining jaws movable between open and closed positions,
each head having a first socket formed therein,
two handles respectively associated with the heads,
each handle being formed of electrically insulating material and having a second socket formed in an end thereof, and
two connecting pins respectively associated with the heads,
each pin having a first end fixedly and permanently secured in the first socket of the associated head and a second end fixedly and permanently secured in the second socket of the associated handle.

12. The hand tool of claim 11, wherein the head assembly is formed of metal.

13. The hand tool of claim 11, wherein each of the heads has a neck portion in which the first socket is formed.

14. The hand tool of claim 11, wherein each pin is press-fitted in each of its associated first and second sockets.

15. The hand tool of claim 11, wherein each pin is formed of metal.

16. The hand tool of claim 11, wherein each pin has a longitudinally knurled external surface.

17. The hand tool of claim 11, wherein each end of each pin is chamfered.

18. The hand tool of claim 11, wherein each handle includes a core formed of a first relatively rigid material and an outer grip sheath covering the core and formed of an elastomeric material.

19. The hand tool of claim 18, wherein each core includes an inner body formed of a glass-fiber-reinforced polyester pultrusion and an outer body formed of glass-fiber-reinforced epoxy braided material.
